(19) United States
(12) Patent Application Publication
(10) Pub. No.: US 2023/0032933 A1
(43) Pub. Date: Feb. 2, 2023

(54) Electrical Power Distribution System

(71) Applicant: Elexsys IP Pty Ltd, Queensland (AU)

(72) Inventor: Geoffrey JAMES, New South Wales (AU)

(21) Appl. No.: 17/641,422

(22) PCT Filed: Sep. 9, 2020
(86) PCT No.: PCT/AU2020/050952

§ 371 Date: Mar. 8, 2022

(30) Foreign Application Priority Data
Sep. 9, 2019 (AU) 2019 903329

(51) Int. Cl. H02J 3/32; H02J 3/38; H02J 3/46; H02J 3/00

(52) U.S. Cl. CPC H02J 3/32; H02J 3/381; H02J 3/466; H02J 3/003; H02J 2300/20

(57) ABSTRACT

The invention relates to an electrical power distribution system, including: an energy storage unit connectable to a power supply and configured to store electrical energy supplied by the power supply; a splitter connected to the energy storage unit and connectable to a grid and a micro-grid, the splitter being configured to split electrical energy supplied by the energy storage unit to allow electrical energy to be controllably supplied to the grid and/or the micro-grid; a splitter meter connected to the splitter, the splitter meter being configured to measure an amount of electrical energy supplied by the energy storage unit to the micro-grid; and electronic controlling devices coupled to the splitter, the one or more electronic controlling devices being configured to: determine a micro-grid load requirement; and control the splitter to cause electrical energy to be supplied to the micro-grid in accordance with the micro-grid load requirement.

### BACKGROUND OF THE INVENTION

The present invention relates to an electrical power distribution system, and in one particular example, an electrical power distribution system including renewable power generators.

### DESCRIPTION OF THE PRIOR ART

Solar power and other renewable energy technologies continue to grow rapidly globally both to mitigate release of carbon and reduce electricity costs. In some countries, the majority of solar power generators are located on end user premises, with energy generated being fed into the mains electricity grid. This situation can be problematic for grid operators as they have little control over the feed in of electricity, which can in turn disrupt operation of the grid, for example by raising the grid voltage outside of statutory target ranges, which can in turn impact on customers, for example damaging electrical equipment or similar. This issue is particularly problematic in industrial or commercial sectors, where renewable capacities can be high, and in turn can cause significant disruption.

US20160226254 relates to a method and apparatus disclosed relating to smart renewable power generation systems with grid and DC source flexibility that can (1) intelligently and selectively pull power from one or multiple DC sources including solar panels, wind generators, and batteries based on certain criteria; (2) invert DC power to AC power; (3) supply the AC power to the electric grid or to an off-grid electric circuit to power AC loads; (4) supply DC power through one or multiple DC output ports to power DC loads; and (5) charge batteries. Various types of on-grid, off-grid, and on/off-grid DC flexible power inverters are described to demonstrate the innovation for delivering flexible, cost-effective, and user-friendly power generation systems to harvest any form of renewable energy available and convert it to usable electricity.

CN202004468 relates to a new-energy power system, belonging to the technical field of new-energy control and application. The system comprises a new-energy power supply device, a maximum power point tracking (MPPT) circuit 2, a clamping switch and a current divider, a charger, an alternating-current to direct-current converter, a power regulation and control manager, an inverter, a mains supply, a user load, a system power supply, a communication module and an interface, a software module, an electric control switch, a monitoring module and storage battery packs. Since an independent parallel working method is adopted for the storage battery packs, one storage battery compensates power to a charging circuit and a clamping circuit automatically completes connection and disconnection to realize automatic power compensation, the system is simple and convenient, investment is saved, efficiency is improved and losses are reduced; since the mains supply and new-energy power are planned as a whole to supply power, multivariate and multi-channel regulation, control and management are conducted, according to set safety electric quantity, not only can the economy of electricity be ensured, but also an effect of using electricity safely is reached, and particularly, the all-weather support of the mains supply and the safety emergency use of stored power are effectively executed.

CN202019211 relates to solar electric power storage and supply, and in particular relates to an off-grid independent solar electric power storage and supply system. In the system, a power supply path from a solar circuit to an alternative current (AC) load is formed by connecting a solar power generation assembly, a monitoring protection circuit, a maximum power point tracking (MPPT) and direct current (DC)/DC circuit, a power regulating circuit, an inverter circuit, a monitoring protection circuit and an AC load. Simultaneously, a plurality of battery packs, a monitoring and selective-control switch circuit B, an automatic power supplement circuit and the power regulating circuit are connected, and a power storage capacitor, the automatic power supplement circuit and the power regulating circuit are connected to form a power supplement circuit path, so that the unstable solar circuit is stabilized in a manner of power supplement and the power demand when the load power is changed can be met; when the stability of the power supply is ensured, the influence and damage of transient large current to a storage battery are effectively eliminated by the power supplement and supply of the storage capacitor while the stability of the power supply is guaranteed; and on the premise of the same power supply capacity, battery allocation and investment are saved by over 60 percent, and the utilization rate of the solar energy power is greatly improved.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In one broad form an aspect of the present invention seeks to provide an electrical power distribution system, including: an energy storage unit connectable to a power supply and configured to store electrical energy supplied by the power supply; a splitter connected to the energy storage unit and connectable to a grid and a micro-grid, the splitter being configured to split electrical energy supplied by the energy storage unit to allow electrical energy to be controllably supplied to the grid and/or the micro-grid; a splitter meter connected to the splitter, the splitter meter being configured to measure an amount of electrical energy supplied by the energy storage unit to the micro-grid; and one or more electronic controlling devices coupled to the splitter, the one or more electronic controlling devices being configured to: determine a micro-grid load requirement; and control the splitter to cause electrical energy to be supplied to the micro-grid in accordance with the micro-grid load requirement.

In one embodiment the splitter is connectable to the grid via a grid meter and a grid bus.

In one embodiment the power supply includes at least one of: a power generator connected to a grid bus; and, the grid.

In one embodiment the power generator includes at least one of: a high-voltage power generator; a solar power generator; a hydrokinetic power generator; and, a wind power generator.

In one embodiment the micro-grid is connectable to the grid via a micro-grid bus and a micro-grid meter.

In one embodiment the micro-grid includes: a micro-grid power generator; and, a load connected to the micro-grid power generator via a micro-grid bus.

In one embodiment the micro-grid power generator is connected to a micro-grid generator meter configured to measure an amount of electrical energy supplied by the micro-grid power generator to the micro-grid.

In one embodiment the micro-grid power generator includes at least one of: a low-voltage solar power generator; and, a diesel power generator.

In one embodiment the diesel power generator further includes a diesel power bus.

In one embodiment the energy storage unit is at least one of: a lead-acid battery; a lithium-ion battery; a fuel cell; and, a set of batteries in series and/or parallel.

In one embodiment the one or more electronic controlling devices is configured to: determine an amount of energy in the energy storage unit; determine condition of the grid; and, feed power from the energy storage unit to the grid according to the condition.

In one embodiment the condition of the grid is at least one of: a grid voltage; a grid frequency; a grid impedance; timing of feed-in; and, an input from a grid operator.

In one embodiment the splitter includes one or more switches for selectively connecting the energy storage unit to the micro-grid or the grid.

In one embodiment the splitter includes one or more power converters connectable to the energy storage unit.

In one embodiment the splitter includes a plurality of switches, each connectable to a respective converter.

In one embodiment the respective converter is connectable to a respective energy storage unit.

In one embodiment the one or more electronic controlling devices being configured to control the plurality of the switches to selectively connect a first number of the switches to the micro-grid and a second number of the switches to the grid.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which:—

FIG. 1 is a schematic diagram of an example of an electrical power distribution system;

FIG. 2 is a flow chart of an example of an operation of an electrical power distribution system ;

FIG. 3 is a schematic diagram of an example of a processing system;

FIG. 4 is a schematic diagram of an example of an electrical power distribution system; and,

FIG. 5 is a schematic diagram of an example of a splitter provided in an electrical power distribution system.

### DETAILED DESCRIPTION OF THE PREFERRED EMBODIMENTS

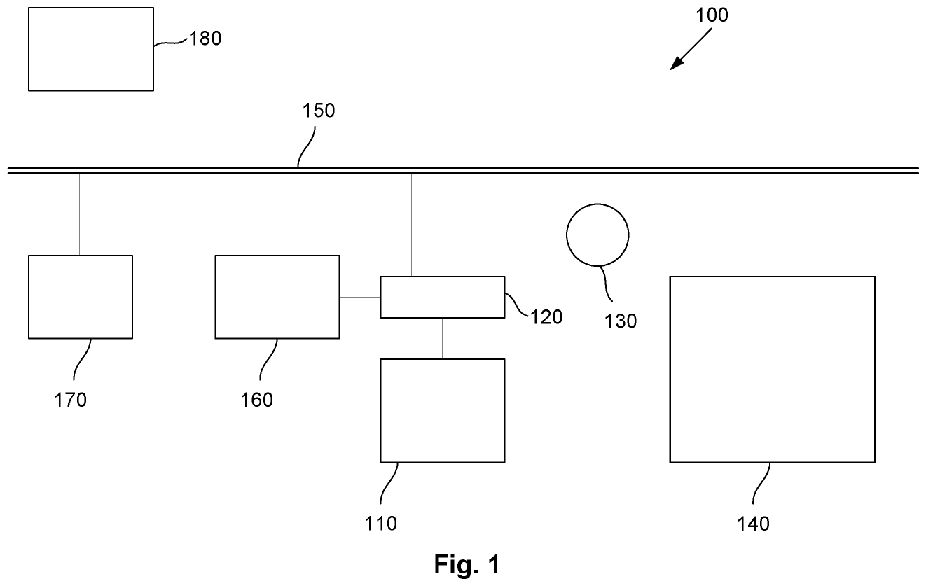

An example of an electrical power distribution system will now be described with reference to FIG. 1.

An electrical power distribution system 100 includes an energy storage unit 110, a splitter 120 and a splitter meter 130. The energy storage unit 110 may be a lead-acid battery, a lithium-ion battery, a fuel cell or a set of batteries in series and/or parallel. The energy storage unit 110 is connectable to a power supply and configured to store electrical energy supplied by the power supply. The power supply may be one or more of a grid 180 and a power generator 170. The power generator 170 may be one or more of solar power generator, hydrokinetic power generator, wind power generator, or any kind of variable power generator having output being not fully controllable within the capacity of the generator.

The splitter 120 is connected to the energy storage unit 110 and connectable to a grid 180 and a micro-grid 140. The micro-grid 140 may include one or more customer loads, one or more power generators and/or one or more energy storage units.

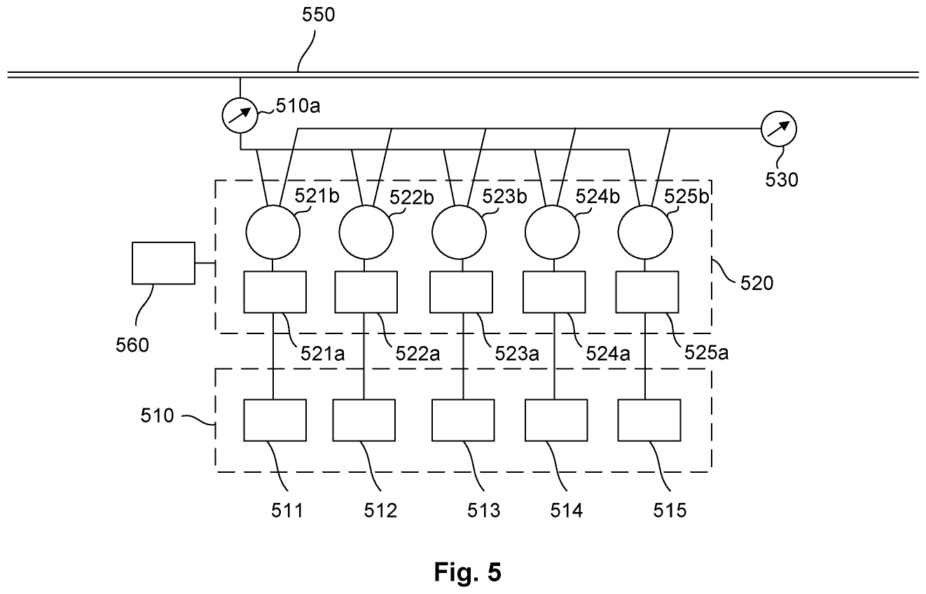

In this example, the splitter 120 is connected to the grid 180 via a grid bus 150. The splitter 120 is configured to split electrical power supplied by the energy storage unit 110, and allows electrical power to be controllably supplied to the grid 180 and/or the micro-grid 140. The splitter 120 could be of any appropriate form, and an example is described in detail with reference to FIG. 5. The splitter 120 is connectable to the micro-grid 140 via the splitter meter 130. The splitter meter 130 is configured to measure an amount of electrical power supplied by the energy storage unit 110 to the micro-grid 140.

It should be appreciated that power converters between alternating current (AC) and direct current (DC), although not shown in FIG. 1, can be implemented when necessary. In an example, the grid 180 is an AC grid then the grid bus 150 would usually, but not necessarily, be an AC bus. In this example, power converters are generally implemented, so that the energy storage unit 110 and the power generator 170 are able to produce AC power when discharging or generating, and the energy storage unit 110 can receive AC power when charging.

The electrical power distribution system 100 further includes one or more electronic controlling devices 160 coupled to the splitter 120. The one or more electronic controlling devices 160 are configured to determine a micro-grid load requirement and control the splitter 120 to cause electrical power to be supplied to the micro-grid 140 in accordance with the micro-grid load requirement. Accordingly, the one or more controlling devices 160 may be formed from any suitable processing device that is capable of processing measurement data, and could include a microprocessor, microchip processor, logic gate configuration, firmware optionally associated with implementing logic such as an FPGA (Field Programmable Gate Array), or any other electronic device, system or arrangement. Furthermore, for ease of illustration the remaining description will refer to a processing device, but it will be appreciated that multiple processing devices could be used, with processing distributed between the devices as needed, and that reference to the singular encompasses the plural arrangement and vice versa.

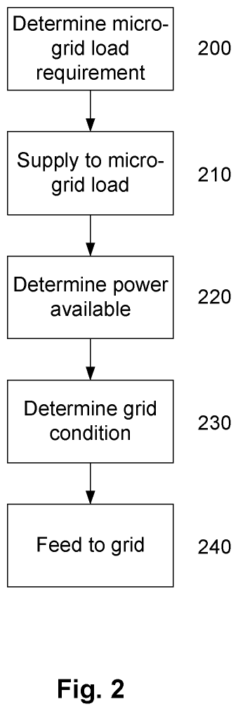

An example of operation of the electrical power distribution system 100 will now be described with reference to FIG. 2.

In this example, at step 200, the electronic controlling device 160 determines a micro-grid load requirement by determining a load requirement. The load requirement could be determined in any one of a number of manners, and could be directly measured from suitable sensors, such as current sensors installed on the micro-grid 140, or could be retrieved or received from a device that measures the load and provides a load indication to the electronic controlling device 160. The load requirement could be equal to or different from the load indication. For example, for demand management, the load requirement would often be less than the load indication, but for backup power, the load requirement would often be equal to the load indication.

At step 210, the electronic controlling device 160 controls the splitter 120 to draw power from the energy storage unit 110 and supplies to the micro-grid load according to the load requirement.

At step 220, the electronic controlling device 160 determines an amount of power available to be delivered from the energy storage unit 110. If the amount of power available to be delivered is greater than the micro-grid load requirement, at step 230, the electronic controlling device 160 determines a condition of the grid for preparing for feed-in. The condition of the grid can be the grid voltage, frequency, impedance, and/or a timing of feed-in, or it can be an input provided by the grid operator according to the needs to operate the grid. The electronic controlling device 160 feeds the power from the energy storage unit 110, which is in excess of the load requirement, to the grid at step 240.

If the amount of energy left in the energy storage unit 110 is insufficient, the electronic controlling device 160 controls the splitter 120 to draw power from the power supply for charging the energy storage unit 110. As mentioned above, the power supply may be one or more of the grid 180 and the power generator 170.

The arrangement of the above described system 100 allows the power output from the battery be measured precisely, so that the impact of feeding excess power back into the grid is minimised.

In particular, this allows the micro-grid to be supplied solely by the battery, thereby reducing load on the grid. Additionally, the battery is recharged from the renewable power supply, either directly, or via the grid, thereby effectively reducing the excess energy supplied into the grid, which in turn helps control grid loading. This therefore maximises the usage of the renewable power, and ensures the battery is fully charged, thereby allowing this to be used to supply the micro-grid when the renewable power supply is generating less than that required by the micro-grid.

In another example of operation of the electrical power distribution system, which is applicable at times when the micro-grid power generator is producing more power than the load requires, the electronic controlling device 160 determines a micro-grid load requirement that is an excess of power generation. In this case, which is different to the example shown in FIG. 2, the electronic controlling device 160 controls the splitter 120 to direct the excess of power generation from the micro-grid to the energy storage unit 110. The electronic controlling device 160 also determines a condition of the grid for preparing for feed-in, and feeds the power from the energy storage unit 110, which may be equal to or different from the excess of power generation, to the grid 180.

Such an arrangement allows more rooftop solar or other renewable energy sources to be installed. With the splitter and the electronic controlling device, the battery is able to manage its output to the load and to the grid, which assists in distribution of energy or power, particularly in feeding to the grid.

A number of further features will now be described.

The splitter is connectable to the grid via a grid meter and a grid bus. This allows the energy storage unit to feed energy to the grid, and the amount of energy or power can be measured. The energy fed to the grid can be an excess energy from the energy storage unit or the energy required by the grid to maintain grid reliability.

The micro-grid is connectable to the grid via a micro-grid bus and a micro-grid meter, so that the grid is able to supply to the micro-grid in addition or alternative to the supply from the energy storage unit, when the supply from the energy storage unit is insufficient or unstable.

Furthermore, the micro-grid may include a micro-grid power generator and a load connected to the micro-grid power generator via a micro-grid bus. And the micro-grid power generator may be at least one or more of a low-voltage solar power generator and a diesel power generator. In the event there are a plurality of diesel power generators, the diesel power generators are connected to the micro-grid via a diesel power bus. This allows a greater range of different renewable power generators to be interconnected so that the energy harvested can be stored in the energy storage unit for use by the load.

Additionally, each micro-grid power generator is connected to a micro-grid generator meter for measuring an amount of electrical energy harvested by the micro-grid power generator.

In one embodiment, the splitter includes one or more switches for selectively connecting the energy storage unit to the micro-grid or the grid. Additionally, the splitter may include one or more power converters connectable to the energy storage unit. This allows the system to operate with either an AC grid or a DC grid.

In one embodiment, the splitter includes a plurality of switches, each connectable to a respective converter. Similarly, the respective converter may be connectable to a respective energy storage unit. In this embodiment, the one or more electronic controlling devices can be configured to control the switches to selectively connect a first number of the switches to the micro-grid and a second number of the switches to the grid. Adjusting the first and second numbers allows the system to control the amount of energy or power delivered to the micro-grid and or fed to the grid, for example by adjusting the proportion of thereby energy fed to the grid versus the micro grid.

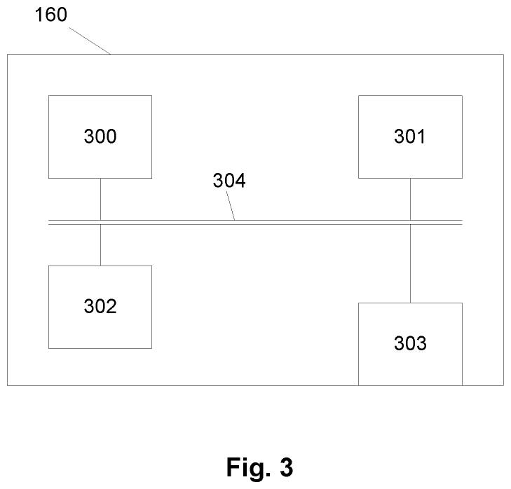

An example of a controller will now be described with reference to FIG. 3.

In this example, the electronic controlling device 160 includes at least one microprocessor 300, a memory 301, an optional input/output device 302, such as a keyboard and/or display, an interface 303, interconnected via a bus 304 as shown. In this example the interface 303 can be utilised for connecting the electronic controlling device 160 to peripheral devices, such as communications networks, or the like.

In use, the microprocessor 300 executes instructions in the form of applications software stored in the memory 301 to allow the required processes to be performed, including controlling the electronic controlling device 160. The applications software may include one or more software modules, and may be executed in a suitable execution environment, such as an operating system environment, or the like.

Accordingly, it will be appreciated that the electronic controlling device 160 may be formed from any suitable control system and could include be any electronic processing device such as a microprocessor, microchip processor, logic gate configuration, firmware optionally associated with implementing logic such as an FPGA (Field Programmable Gate Array), or any other electronic device, system or arrangement.

However, it will be appreciated that the above described configuration assumed for the purpose of the following examples is not essential, and numerous other configurations may be used. It will also be appreciated that the partitioning of functionality between the different processing systems may vary, depending on the particular implementation.

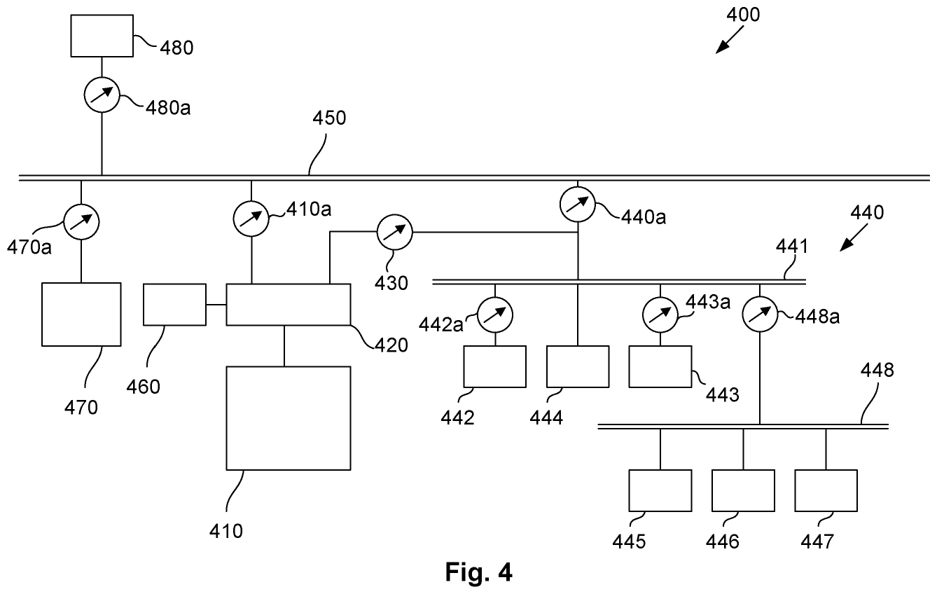

An example of the electrical power distribution system will now be described in more detail with reference to FIG. 4.

The electrical power distribution system 400 includes an energy storage unit 410, a splitter 420 and a splitter meter 430. The energy storage unit 410 is a battery or a set of batteries in series and/or parallel. The energy storage unit 410 is connected to a power supply 470 and configured to store electrical energy supplied by the power supply 470. In this example, the power supply 470 is a high voltage (HV) solar power generator. The HV solar power generator is connected to a grid bus 450 via a HV solar power meter 470a.

The splitter 420 is connected to the energy storage unit 410 and also to a grid 480 and a micro-grid 440. In this example, the splitter is connected to the grid 480 via the grid bus 450 and connected to a micro-grid 440 via a micro-grid bus 441. The splitter 420 is configured to split electrical energy supplied by the battery 410, and allows electrical power to be controllably supplied to the grid 480 and/or the micro-grid 440. The splitter 420 is connectable to the micro-grid 440 via the splitter meter 430, which is configured to measure an amount of electrical energy supplied by the battery 410 to the micro-grid 440.

In this example, the micro-grid 440 includes two low voltage (LV) solar power generators 442, 443, a load 444 and three diesel power generators 445, 446, 447. The LV solar power generators 442, 443 are connected to the micro-grid bus 441 via respective LV solar power meters 442a, 443a. The diesel power generators 445, 446, 447 are connected to the micro-grid bus 441 via a diesel power bus 448 and a diesel power meter 448a. The load 444 may be a number of household and/or a secondary power distribution centre. The micro-grid 440 is also connected to the grid bus 450 via a micro-grid meter 440a. The micro-grid 440 is configured to consume electrical power at times, and may generate electrical power at times due to an excess of power generation compared to the load or loads.

The electrical power distribution system 400 further includes an electronic controlling device 460 coupled to the splitter 420. The electronic controlling device 460 is configured to determine a micro-grid load requirement and control the splitter 420 to cause electrical energy to be supplied to the micro-grid 440 in accordance with the micro-grid load requirement. In an example, the micro-grid load requirement is determined by the net effect of the load 444 and the power generators including LV solar power generators 442, 443 and the diesel power generators 445, 446, 447.

In operation, the electrical power distribution system 400 stores energy harvested from the HV solar power generator 470 in the battery 410 via the grid bus 450. The battery also stores energy harvested from the LV solar power generators 442, 443 and/or the diesel power generators 445, 446, 447 via the micro-grid bus 441. The battery 410 feeds power to the grid bus 450 and/or to the micro-load 440 through the splitter 420. The electronic controlling device 460 that is connected to the splitter 420 determines a requirement of the micro-grid load 440. In this example, the electronic controlling device 460 measures the requirement of the load 444. Based on the measurement, the electronic controlling device 460 controls the splitter 420 to draw the energy from the battery 410 and supplies power to the load 444. The splitter meter 430 measures an actual power fed to the load 444. The electronic controlling device 460 determines an amount of energy left in the battery 410 according to the splitter meter 430. When the amount of energy left is sufficient, the electronic controlling device 460 determines a condition of the grid 480 or the grid bus 450. The condition of the grid 480 can be the grid voltage, frequency, impedance, and/or a timing of feed-in or it can be an input provided by the grid operator according to the needs to operate the grid. The electronic controlling device 460 feeds the energy from the battery 410 to the grid 480 based on the condition.

Furthermore, the grid 480 is a registered power network and managed by a grid operator. The connection point of the grid 480 and the HV grid bus 450 is a parent connection point and is registered with the energy retailer. It is an unscheduled market customer, because no generation is settled against it. The HV solar power generator 470 connected to the HV grid bus 450 has a child connection point which will be registered as an unscheduled market generator, being less than 30 MW. The LV solar power generators 442, 443 connected to the micro-grid bus 441 are less than the minimum load and therefore operates as zero-export generation. The connection points at meters 442a, 443a do not need to be registered.

Additionally, the frequency control ancillary services (FCAS) may be provided to charge and discharge the battery 410 simultaneously. In one example, the battery 410 is able to perform peak load management and spot market trading simultaneously. Therefore, the battery 410 has a child connection point to the grid bus 450, which is a registered connection point and charged (as a market customer) and discharged (as a market generator) separately.

The battery 410 is unscheduled due to its small size, while still participating in FCAS dispatch. One of the backup diesel generators 445, 446, 447 may be connected for market participation and with a third energy retailer. This is also a child connection point registered as an unscheduled market generator.

In this example, the meters are categorised as market or non-market meters. Meters 480a, 410a, 440a and 470a are market meters, whereas meters 430, 442a, 443a and 448a are non-market meters. Each meter may also be owned by different parties, which allows the energy from these generators to be settled by different energy retailers. The nonmarket meters are configured to measure and settle off-market sales of energy supplied to the load 444, for which the splitter 420 directs some energy from the battery 410 for off-market settlement with the load 444.

The amounts of energy settled at each market meter is calculated based on at least one of BL=battery charging, BG=battery discharging, CL=load minus LV solar generation, DG=HV solar generation, MML=site net load, and MMG=site net generation.

The electrical power distribution system 400 allows more rooftop solar to be installed. With the splitter and the electronic controlling device, the battery is able to manage its output to the load and to the grid, which assists in distribution of energy, particularly in feeding to the grid.

An example of the splitter will now be described in more detail with reference to FIG. 5.

In this example, the energy storage unit 510 includes five batteries 511, 512, 513, 514, 515. The splitter 520 includes five power converters 521a, 522a, 523a, 524a, 525a, each connects to a respective battery, so that each battery is capable of producing AC power when discharging and receiving AC power when charging. The splitter 520 further includes corresponding switches 521b, 522b, 523b, 524b, 525b, each couples to the respective batteries 511, 512, 513, 514, 515 via the respective converters 521a, 522a, 523a, 524a, 525a. The energy storage unit 510 is configured to direct AC power to or from either the grid bus 550 or the micro-grid via the splitter. Each of the switches 521b, 522b, 523b, 524b, 525b can be configured independently to output to or receive from the grid bus 550 or the micro-grid via the splitter meter 530. This permits a variable amount of power output from the batteries to be directed to the grid bus 550, and a variable amount of power output from the batteries to be directed to the splitter meter 530. Additionally, this permits power input to the batteries to be obtained partly from the grid bus 550, and partly from the micro-grid via the splitter meter 530. It should also be appreciated that the power converters may be integrated with the energy storage unit 510, instead of or in addition to being integrated with the splitter 520. It should be appreciated that the number of batteries, power converters and the switches described herein are exemplary only, any suitable numbers may be implemented.

In operation, the electronic controlling device 560 controls the splitter 520 to selectively connect the energy storage unit 510 to the grid bus 550 and the micro-grid via the splitter meter 530. The electronic controlling device 560 controls the switches 521b, 522b, 523b, 524b, 525b, so that a number of the batteries connect to the grid and the remaining batteries connect to the micro-grid. In an example, the electronic controlling device 560 may control the switches in the splitter 520, so that three batteries 511, 512, 513 supply to the grid bus 550 and two batteries 514, 515 supply to the micro-grid. As a result, the energy in the energy storage unit 510 is split into supplying the grid and the micro-grid.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1. An electrical power distribution system, including:
a) an energy storage unit connectable to a power supply and configured to store electrical energy supplied by the power supply;
b) a splitter connected to the energy storage unit and connectable to a grid and a micro-grid, the splitter being configured to split electrical energy supplied by the energy storage unit to allow electrical energy to be controllably supplied to the grid and/or the micro-grid;
c) a splitter meter connected to the splitter, the splitter meter being configured to measure an amount of electrical energy supplied by the energy storage unit to the micro-grid; and
d) one or more electronic controlling devices coupled to the splitter, the one or more electronic controlling devices being configured to:
i) determine a micro-grid load requirement; and
ii) control the splitter to cause electrical energy to be supplied to the micro-grid in accordance with the micro-grid load requirement.

2. The electrical power distribution system according to claim 1, wherein the splitter is connectable to the grid via a grid meter and a grid bus.

3. The electrical power distribution system according to claim 1 or 2, wherein the power supply includes at least one of:
a) a power generator connected to a grid bus; and,
b) the grid.

4. The electrical power distribution system according to claim 3, wherein the power generator includes at least one of:
a) a high-voltage power generator;
b) a solar power generator;
c) a hydrokinetic power generator; and,
d) a wind power generator.

5. The electrical power distribution system according to any one of claims 1 to 4, wherein the micro-grid is connectable to the grid via a micro-grid bus and a micro-grid meter.

6. The electrical power distribution system according to any one of claims 1 to 5, wherein the micro-grid includes:
a) a micro-grid power generator; and,
b) a load connected to the micro-grid power generator via a micro-grid bus.

7. The electrical power distribution system according to claim 6, wherein the micro-grid power generator is connected to a micro-grid generator meter configured to measure an amount of electrical energy supplied by the micro-grid power generator to the micro-grid.

8. The electrical power distribution system according to claim 6 or claim 7, wherein the micro-grid power generator includes at least one of:
a) a low-voltage solar power generator; and,
b) a diesel power generator.

9. The electrical power distribution system according to claim 8, wherein the diesel power generator further includes a diesel power bus.

10. The electrical power distribution system according to any one of the preceding claims, wherein the energy storage unit is at least one of:
a) a lead-acid battery;
b) a lithium-ion battery;
c) a fuel cell; and,
d) a set of batteries in series and/or parallel.

11. The electrical power distribution system according to any one of the preceding claims, wherein the one or more electronic controlling devices is configured to:
a) determine an amount of energy in the energy storage unit;
b) determine condition of the grid; and,
c) feed power from the energy storage unit to the grid according to the condition.

12. The electrical power distribution system according to claim 11, wherein the condition of the grid is at least one of:
a) a grid voltage;
b) a grid frequency;
c) a grid impedance;
d) timing of feed-in; and,
e) an input from a grid operator.

13. The electrical power distribution system according to any one of the preceding claims, wherein the splitter includes one or more switches for selectively connecting the energy storage unit to the micro-grid or the grid.

14. The electrical power distribution system according to any one of the preceding claims, wherein the splitter includes one or more power converters connectable to the energy storage unit.

15. The electrical power distribution system according to any one of the preceding claims, wherein the splitter includes a plurality of switches, each connectable to a respective converter.

16. The electrical power distribution system according to claim 15, wherein the respective converter is connectable to a respective energy storage unit.

17. The electrical power distribution system according to claim 15 or 16, wherein the one or more electronic controlling devices being configured to control the plurality of the switches to selectively connect a first number of the switches to the micro-grid and a second number of the switches to the grid.
